(19) United States
(12) Patent Application Publication
(10) Pub. No.: US 2023/0065771 A1
(43) Pub. Date: Mar. 2, 2023

(54) Movable Thick and Dehydration Device for Eluent Sediment from medium- and low-concentration ammonia Nitrogen Eluviation and Method Thereof

(71) Applicant: Ganzhou KeQing Environment Engineering Ltd, Ganzhou City (CN)

(72) Inventors: Guocai Zhu, Beijing City (CN); Shaofeng Liu, Beijing City (CN); Maolin Yu, Ganzhou City (CN)

(21) Appl. No.: 17/504,542

(22) Filed: Oct. 19, 2021

(30) Foreign Application Priority Data
Aug. 30, 2021 (CN) 2021110020209

(51) Int. Cl. C02F 9/00; C02F 1/00

(52) U.S. Cl. CPC C02F 9/00; C02F 1/006; C02F 1/008; C02F 1/66

(57) ABSTRACT

Movable thick dehydration device and method for eluent sediment from medium- and low-concentration ammonia nitrogen are provided. The device integrates the existing eluent preparing mechanism, a transferring mechanism, pumping mechanisms, a transport vehicle, an automatic controlling system, an eluent collecting pool, primary and secondary sedimentation pools, and primary and secondary processing units. After post-treatment and recovery of eluent waste from rare earth mines, ammonia nitrogen and rare earth heavy metals in the eluent of rare earth mines can be recovered and disposed, and 90% of ammonia nitrogen and over 95% of rare earth in the eluent can be recycled. The device is movable and automated, and therefore suitable for environmental treatment of closed rare earth mines with residual ammonia nitrogen. Meanwhile, it is beneficial to reduce investment costs of capital construction, disposal site restoration of environmental treatment of rare earth mines with residual ammonia nitrogen.

### TECHNICAL FIELD

The invention relates to technical field of sewage treatment, in particular to a movable thick and dehydration device for the sediment from medium- and low-concentration ammonia nitrogen and a method thereof.

### BACKGROUND

Ammonium sulfate is mainly used as leaching agent in ionic rare earth mining. After the rare earth mining is completed, the residual leaching agent continues to penetrate into the water body along the rain, which causes seriously environmental problems, i.e., excessive ammonia in water body and excessive heavy metals in the mining area, and endangers harm to the production and livelihood of the people in the mining area. Nowadays rare earth is an important strategic resource, so environmental protection must be strengthened to realize green and sustainable development of resources alongside exploitation.

The existing patent application discloses an ammonium ion eluant and its application (Chinese Patent Application No. 202011275941.8, which is corresponding to the Patent Pub. No. CN112517620A), which solves the environmental pollution problem caused by ionic rare earth mining by applying the ferrous salt eluting method, elutes out residual ammonia nitrogen and rare earth in ionic rare earth leaching mine, and uses the sedimentation method to enrich rare earth and remove ammonia nitrogen in eluent. Because of the low concentration of impurities and ammonia nitrogen in eluent, large equipment will be used for leaching and deamination in mines, which will increase the cost of infrastructure construction and equipment investment. Therefore, it is necessary to develop movable, continuous and automatic solid-liquid separating and treating equipment with small footprint, which is more conducive to the popularization and application of this technology.

### SUMMARY OF INVENTION

An objective of the invention is to provide a movable thick and dehydration device for eluent sediment from medium- and low-concentration ammonia nitrogen eluviation and a method thereof, so as to solve the problems above in the prior art, which can remove and recover ammonia nitrogen in rare earth ore eluent, realize the movable, continuous and automatic operation of the purifying equipment, and simultaneously cut down costs of infrastructure construction, disposal site restoration and investment costs.

To achieve the above objectives, the invention provides the following scheme.

Specifically, the invention provides a movable thick and dehydration device for an eluent sediment from medium- and low-concentration ammonia nitrogen, which includes a container, an eluent preparing mechanism, a transferring mechanism, a plurality of pumping mechanisms, a transport vehicle and a purifying device set on the transport vehicle. The purifying device includes an automatic controlling system, an eluent collecting pool, a primary sediment pool, a secondary sedimentation pool, a primary processing unit and a secondary processing unit; the primary processing unit and the secondary processing unit are both set in the container.

Moreover, the eluent collecting pool is connected to and communicated with an external mine eluent waste liquid port, and the eluent collecting pool is connected to and communicated with the primary sedimentation pool through the pumping mechanism; The primary sedimentation pool is fixedly connected to and communicated with the primary processing unit through the pumping mechanism; The primary processing unit and the secondary processing unit are fixedly connected to and communicated with the secondary sedimentation pool through the pumping mechanisms; the primary processing unit is communicated with the transferring mechanism, and the secondary processing unit is communicated with the eluent preparing mechanism and the transferring mechanism respectively; the automatic controlling system is fixedly installed on the primary sedimentation pool, the secondary sedimentation pool, the primary processing unit and the secondary processing unit respectively, and the automatic controlling system is further electrically connected to the plurality of pumping mechanisms.

In a preferred embodiment, the primary processing unit includes a primary thickener, a primary spiral dehydrator and a primary sand filtering purifier, which are respectively fixedly arranged on a bottom surface of an inner cavity of the container; the primary sedimentation pool is fixedly connected to and communicated with the primary thickener through the pumping mechanism; the primary thickener is fixedly connected to and communicated with the primary sand filtering purifier and the primary spiral dehydrator through two of the pumping mechanisms respectively; the primary sand filtering purifier is fixedly connected to and communicated with the secondary sedimentation pool through the pumping mechanism; the secondary sedimentation pool is fixedly connected to and communicated with the secondary processing unit through the pumping mechanism; and the primary spiral dehydrator is communicated with the transferring mechanism.

In a preferred embodiment, the secondary processing unit includes a secondary thickener, a secondary spiral dehydrator and a second sand filter liquid purifier which are respectively fixedly arranged on the bottom surface of the inner cavity of the container; the secondary sedimentation pool is fixedly connected to and communicated with the secondary thickener through the pumping mechanism. The secondary thickener is fixedly connected to and communicated with the secondary sand filtering purifier and the secondary spiral dehydrator through two of the pumping mechanisms respectively; the secondary sand filtering purifier is fixedly connected to and communicated with the eluent preparing mechanism through the pumping mechanism; and the secondary spiral dehydrator is communicated with the transferring mechanism.

In a preferred embodiment, the automatic controlling system includes a PLC controller, a plurality of liquid level meters and a plurality of pH meters; The PLC controller is arranged at one side of the primary sedimentation pool; The primary sedimentation pool and the secondary sedimentation pool are respectively fixedly provided with the pH meters; The primary sedimentation pool and the secondary sedimentation pool are respectively fixedly provided with the liquid level meters; and the liquid level meters, the pH meters and the pumping mechanisms are electrically connected to the PLC controller respectively.

In a preferred embodiment, the primary sedimentation pool, the secondary sedimentation pool and the eluent collecting pool all are quick assembly and disassembly structures.

In another aspect, a movable thick and dehydration method for eluent sediment from medium- and low-concentration ammonia nitrogen, comprises the following steps:

liquid collecting: importing the mine eluent into the eluent collecting pool;

primary preparing: importing the eluent into the primary sedimentation pool, and adding lime into the eluent to obtain turbid liquid;

primary multiplex treating: importing the turbid liquid from the primary sedimentation pool into the primary processing unit, and importing the turbid liquid which is processed by the primary processing unit into the secondary sedimentation pool and the transferring mechanism respectively;

secondary preparing: adding sodium dihydrogen phosphate and magnesium sulfate into the secondary sedimentation pool, stirring and resting for reacting for a certain time to obtain suspension; and

secondary multiplex treating: importing the suspension from the secondary sedimentation pool into the secondary processing unit, and importing the suspension which is processed by the secondary processing unit into the eluent preparing mechanism and the transferring mechanism respectively.

In a preferred embodiment, in the step of primary multiplex treating, the turbid liquid of the primary sedimentation pool is imported into the primary thickener for clarifying and stratifying; the supernatant is imported into the primary sand filtering purifier, and the purified liquid is imported into the secondary sedimentation pool; the lower turbid liquid is imported into the primary spiral dehydrator, and the output product of the primary spiral dehydrator is imported into the transferring mechanism.

In a preferred embodiment, in the step of secondary preparing, the time of stirring and resting is 10 min-30 min.

In a preferred embodiment, in the step of secondary multiplex treating, the turbid liquid produced by the reaction in the secondary sedimentation pool is imported into the secondary thickener for clarifying and stratifying; the supernatant is imported into the secondary sand filtering purifier, and the purified liquid is imported into the eluent preparing mechanism; the lower turbid liquid is imported into the secondary spiral dehydrator, and the outlet product from the secondary spiral dehydrator is imported into the transferring mechanism.

The invention can achieve the following technical effects.

In particular, the invention is suitable for treating ionic rare earth mine eluent, which contains 100-1000 ppm of medium- and low-concentration ammonia nitrogen, and rare earth and heavy metal ions can be treated in situ; two-step sedimentation is adopted, which not only recovers the ammonia nitrogen in the eluent, but also recovers the rare earth in the eluent, thus achieving the dual purposes of environmental treatment and resource recovery. In order to facilitate the layout to rare earth mines, the treatment equipment is a vehicle-mounted mobile system.

In addition, according to the invention, the combination of the primary processing unit and the secondary processing unit can be connected in multiple groups in parallel, so that the treatment efficiency of mine waste is improved.

### BRIEF DESCRIPTION OF DRAWINGS

In order to explain the embodiments of the invention or the technical scheme in the prior art more clearly, the following will briefly introduce the drawings used in the embodiments. Obviously, the drawings in the following description are only some embodiments of the invention, and for those of ordinary skill in the art, other drawings can be obtained according to these drawings without paying creative labor.

FIG. 1 is a schematic diagram of an overall structure of the invention.

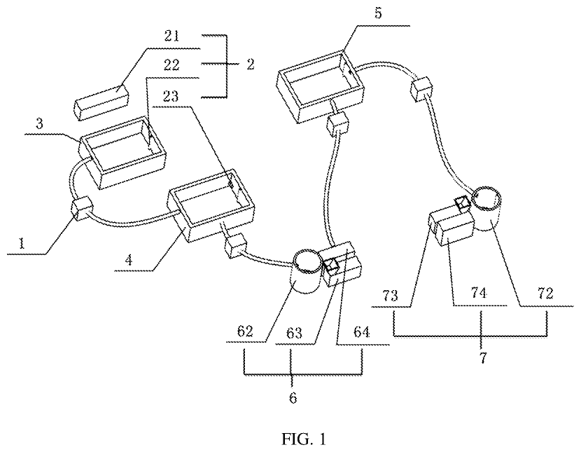

FIG. 2 is a schematic process flow chart of the invention.

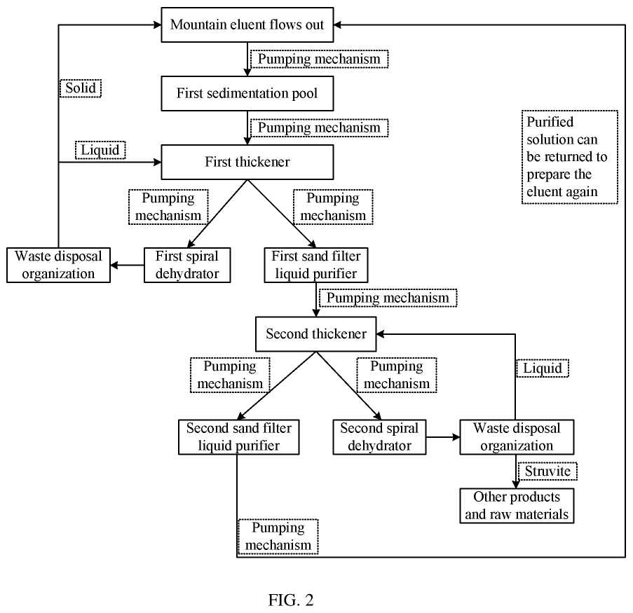

FIG. 3 is a schematic side view of a primary processing unit and a secondary processing unit both attached onto a bottom surface of a container.

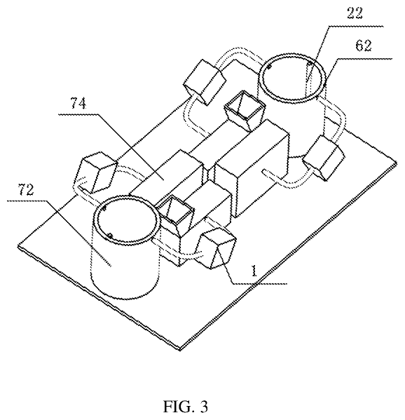

Description of reference numerals: 1—pumping mechanism; 2—automatic controlling system; 21—PLC controller; 22—liquid level meter; 23—pH meter; 3—eluent collecting pool; 4—primary sedimentation pool; 5—secondary sedimentation pool; 6—primary processing unit; 62—primary thickener; 63—primary spiral dehydrator; 64—primary sand filtering purifier; 7—secondary processing unit; 72—secondary thickener; 73—secondary spiral dehydrator; 74—secondary filtering purifier.

### DETAILED DESCRIPTION OF EMBODIMENTS

The following will clearly and completely describe the technical scheme in the embodiments of the invention with reference to the drawings in the embodiments of the invention. Apparently, the described embodiments are only part of the embodiments of the invention, not all of them. Based on the embodiments of the invention, all other embodiments obtained by those of ordinary skill in the art without creative labor shall fall in the scope of protection of the invention.

In order to make the above objectives, features and advantages of the invention more obvious and easier to understand, the invention will be further explained in detail with reference to the drawings and specific embodiments.

The invention provides a movable thick and dehydration device for eluent sediment from medium- and low-concentration ammonia nitrogen, which comprises a container, an eluent preparing mechanism (not shown in the attached figures), a transferring mechanism (not shown in the attached figures), a plurality of (i.e., more than one) pumping mechanisms 1, a transport vehicle (not shown in the attached figure) and a purifying device arranged on the transport vehicle. Specifically, the purifying device includes an automatic controlling system 2, an eluent collecting pool 3, a primary sedimentation pool 4, a secondary sedimentation pool 5, a primary processing unit 6 and a secondary processing unit 7. The primary processing unit 6 and the secondary processing unit 7 are both set in the container.

Further, the pumping mechanism 1 comprises a water incoming pipe, a water outgoing pipe and a self-priming pump connected in series between the water incoming pipe and the water outlet pipe, which can ensure that the solution or mud in the parts at both ends connected with the pumping mechanism 1 can be transmitted.

Further, the transport vehicle may be an existing heavy-duty trailer, and the primary processing unit 6 and the secondary processing unit 7 are arranged in the same container, which is convenient for centralized transportation by the transport vehicle, as well as transportation and layout of the primary processing unit 6 or the secondary processing unit 7.

Further, the eluent preparing mechanism may be a device for forming a solution from ferrous salt and magnesium salt according to the weight ratio of 2:1.

Further, the transferring mechanism may be a device for collecting and treating solid waste and liquid waste according to the disposal method.

Further, the top surfaces of the primary sedimentation pool 4 and the secondary sedimentation pool 5 may be respectively fixed with stirring kettles, which improve the reaction rate of the internal substances.

the eluent collecting pool 3 may be communicated with an external mine eluent waste port, and the eluent collecting pool 3 may be communicated with the primary sedimentation pool (4) through the pumping mechanism 1; the primary sedimentation pool 4 may be fixedly connected to and communicated with the primary processing unit 6 through the pumping mechanism 1; the primary processing unit 6 and the secondary processing unit 7 may be fixedly connected to and communicated with the secondary sedimentation pool 5 through the pumping mechanism 1; the primary processing unit 6 may be communicated with the transferring mechanism, and the secondary processing unit 7 may be individually communicated with the eluent preparing mechanism and the transferring mechanism; the automatic controlling system 2 may be fixedly installed on the primary sedimentation pool 4, the secondary sedimentation pool 5, the primary processing unit 6 and the secondary processing unit 7, and the automatic controlling system 2 may be electrically connected to the plurality of pumping mechanism 1.

Further, the primary processing unit 6 may include a primary thickener 62, a primary spiral dehydrator 63 and a primary sand filtering purifier 64 which are respectively fixedly arranged on a bottom surface of an inner cavity of the container; The primary sedimentation pool 4 is fixedly connected to and communicated with the primary thickener 62 through the pumping mechanism 1; the primary thickener 62 is fixedly connected to and communicated with the primary sand filtering purifier 64 and the primary spiral dehydrator 63 through two of the pumping mechanisms 1 respectively; the primary sand filtering purifier 64 is fixedly connected to and communicated with the secondary sedimentation pool 5 through the pumping mechanism 1, the secondary sedimentation pool 5 is fixedly connected to and communicated with the secondary processing unit 7 through the pumping mechanism 1, and the primary spiral dehydrator 63 is communicated with the transferring mechanism.

Further, the container may be detachable on six sides or provided with flying wings on two sides, and can be freely unfolded, which provides convenience for the layout of the invention.

Further, the primary thickener 62 may be an existing solid-liquid separating device based on gravity sedimentation;

Further, the primary spiral dehydrator 63 may be an existing spiral sludge dehydrator;

Further, the primary sand filtering purifier 64 may be an existing high-efficiency filtering device which uses quartz sand as a filtering medium and filters water with high turbidity through granular or non-granular quartz sand with a certain thickness under a certain pressure, thus finally reducing water turbidity and purifying water quality.

According to a further optimization scheme, a secondary thickener 72, a secondary spiral dehydrator 73 and a secondary sand filtering purifier 74 may be respectively fixedly arranged on the bottom surface of the inner cavity of the container; The secondary sedimentation pool 5 is fixedly connected and communicated with the secondary thickener 72 through the pumping mechanism 1; the secondary thickener 72 is fixedly connected and communicated with the secondary sand filtering purifier 74 and the secondary spiral dehydrator 73 respectively through two pumping mechanisms 1, the secondary sand filtering purifier 74 is fixedly connected and communicated with the eluent preparing mechanism through the pumping mechanism 1, and the secondary spiral dehydrator 73 is communicated with the transferring mechanism.

In a further optimization scheme, the automatic controlling system 2 may include a PLC controller 21, a plurality of liquid level meters 22 and a plurality of pH meters 23; the PLC controller 21 is arranged at one side of the primary sedimentation pool 4; the primary sedimentation pool 4 and the secondary sedimentation pool 5 are respectively fixedly installed with pH meters 23, the primary sedimentation pool 4 and the secondary sedimentation pool 5 are respectively fixedly installed with liquid level meters 22; and the liquid level meters 22, the pH meters 23 and the pumping mechanism 1 are respectively electrically connected with the PLC controller 21.

Further, the PLC controller 21 may be also electrically connected with an alarm; when the PLC controller 21 finds that the pH value reaches the standard preset value, it sends out an audible and visual alarm to prompt to stop the input of auxiliary materials.

In a further optimization scheme, the primary sedimentation pool 4, the secondary sedimentation pool 5 and the eluent collecting pool 3 are all quick assembly and disassembly structures.

An embodiment of the invention relates to a movable thick and dehydration method for eluent sediment from medium- and low-concentration ammonia nitrogen, which comprises the following steps:

liquid collecting: the mine eluent is imported into the eluent collecting pool 3;

primary preparing: the eluent is imported into the primary sedimentation pool 4, and lime is added into the eluent to obtain turbid liquid;

further, the mine eluent is pumped from the eluent collecting pool 3 to the primary sedimentation pool 4 by the pumping mechanism 1, and the volume of the eluent in the primary sedimentation pool 4 is monitored by the liquid level meter 22 fixedly installed on the side wall of the primary sedimentation pool 4; when the specified volume is reached, the corresponding electrical signal is given to the PLC controller 21, which gives the electrical signal to the self-priming pump of the pumping mechanism 1 to stop running, thus controlling the volume of the primary sedimentation pool 4.

At this time, lime is added into the primary sedimentation pool 4, and the pH value of the eluent in the primary sedimentation pool 4 is monitored by the pH meter 23. When the pH value of the eluent reaches 9, the PLC controller 21 controls the alarm to give an audible and visual alarm, prompting people to stop the input of auxiliary materials; the liquid is rested for 10-30 min after stirring; in the process, the primary sedimentation pool 4 will have the reaction to produce a large amount of sediment containing rare earth, thus realizing the enrichment of rare earth elements;

primary multiplex treating: the turbid liquid is imported from the primary sedimentation pool 4 to the primary processing unit 6, and the turbid liquid is imported into the secondary sedimentation pool 5 and the transferring mechanism respectively after being processed by the primary processing unit 6;

secondary preparing: adding sodium dihydrogen phosphate and magnesium sulfate into the secondary sedimentation pool 5, keeping resting for reaction for a certain time after stirring to obtain suspension;

further, sodium dihydrogen phosphate and magnesium sulfate are added into the secondary sedimentation pool 5, and the ratio of sodium dihydrogen phosphate and magnesium sulfate to ammonia in the supernatant is 1:1.5:1-1:1.8:1. After 10 minutes, under the stirring of the stirring kettle, a large amount of magnesium ammonium phosphate, namely struvite sediment, will be precipitated in the secondary sedimentation pool 5.

secondary multiplex treating: the suspension is imported from the secondary sedimentation pool 5 to the secondary processing unit 7, and the suspension is processed by the secondary processing unit 7 and then respectively imported to the eluent preparing mechanism and the transferring mechanism.

In a further optimization scheme, in the step of primary multiplex treating, the turbid liquid of the primary sedimentation pool 4 is imported into the primary thickener 62 for clarifying and stratifying; the supernatant is imported into the primary sand filtering purifier 64, and the purified liquid is imported into the secondary sedimentation pool 5; the lower turbid liquid is imported into the primary spiral dehydrator 63, and the export product of the primary spiral dehydrator 63 is imported into the transferring mechanism.

Further, the pumping mechanism 1 between the primary sedimentation pool 4 and the primary thickener 62 is started by the PLC controller 21, and the volume control of the primary thickener 62 is realized by the liquid level meter 22 arranged in the processing pool of the primary thickener 62; the turbid liquid in the primary sedimentation pool 4 is pumped into the processing pool of the primary thickener 62, which clarifies and stratifies the turbid liquid. The supernatant of the turbid liquid is pumped into the primary sand filtering purifier 64 through the pumping mechanism 1 between the primary thickener 62 and the primary sand filtering purifier 64 for purifying, which can further filter the suspended solid particles in the supernatant, thus avoiding interference caused by entering the next step.

The purified supernatant is pumped into the secondary sedimentation pool 5 through the pumping mechanism 1 between the primary sand filtering purifier 64 and the secondary sedimentation pool 5.

In addition, the primary spiral dehydrator 63 will dehydrate the lower sludge liquid from the turbid liquid, and the dehydrated solid waste will be collected by the transferring mechanism and returned to the mine for re-refining. Meanwhile, the dehydrated wastewater will also be collected by the transferring mechanism and returned to the processing pool of the primary thickener 62, so as to realize re-circulation and collection.

According to another further optimization scheme, in the step of secondary preparing, the time of the stirring and resting is 10 min-30 min.

According to still another further optimization scheme, in the step of secondary multiplex treating, the turbid liquid generated by the reaction of the secondary sedimentation pool 5 is imported into the secondary thickener 72 for clarifying and stratifying; the supernatant is imported into the secondary sand filtering purifier 74, and the purified solution is imported into the eluent preparing mechanism; the lower turbid liquid is imported into the secondary spiral dehydrator 73, and the export product of the secondary spiral dehydrator 73 is imported into the transferring mechanism.

Further, the pumping mechanism 1 between the secondary sedimentation pool 5 and the secondary thickener 72 is started by the PLC controller 21, and the volume control of the secondary thickener 72 is realized by the liquid level meter 22 arranged in the processing pool of the secondary thickener 72; the suspension in the secondary sedimentation pool 5 is pumped into the secondary thickener 72 for clarifying and stratifying, and the supernatant of the suspension is pumped into the secondary sand filtering purifier 74 by the pumping mechanism 1 between the secondary thickener 72 and the secondary sand filtering purifier 74 for purifying, so that the suspended solid particles in the supernatant can be further filtered to avoid interference caused by entering the next step.

The purified supernatant is pumped into the eluent preparing mechanism through the pumping mechanism 1 between the secondary sand filtering purifier 74 and the eluent preparing mechanism to participate in the next eluent allocation, thus reducing the consumption of water resources and environmental pollution.

In addition, the secondary spiral dehydrator 73 dehydrates the lower sludge liquid from the suspension, and the dehydrated solid waste is collected by the transferring mechanism, which can be sold as the raw material of nitrogen and phosphate fertilizer, thus improving the income from sewage treatment; meanwhile, the dehydrated wastewater is also collected by the transferring mechanism and returned to the processing pool of the secondary thickener 72, so as to realize the recycling collection.

### Embodiment 1

5 m³ of simulated eluent containing ammonia nitrogen (NH₄⁺) with a concentration of 200 mg/L, rare earth ions (RE³⁺) with a total concentration of 50 mg/L and iron ions with a content of 800 mg/L is taken, its pH value is adjusted to 9 with lime powder, and then the eluent is pumped into the primary processing unit 6 to obtain 19.8 kg of precipitate containing rare earth and purified supernatant; the content of rare earth and iron in the purified supernatant is less than 0.5 mg/L, and the sedimentation rate of rare earth is more than 99%. Magnesium sulfate and sodium dihydrogen phosphate are added into the purified supernatant, then the purified supernatant is stirred and reacted for 29 min, and subsequently pumped into the secondary processing unit 7 to obtain 25 kg of struvite and the purified supernatant after the second purification, wherein the ammonia nitrogen content of the purified supernatant after the second purification is 15 mg/L, the ammonia nitrogen removal rate is bigger than 92%, and the purified supernatant can be reused for preparing the eluent again.

### Embodiment 2

5 m³ of simulated eluent containing ammonia nitrogen (NH₄⁺) with a concentration of 100 mg/L, rare earth ions (RE³⁺) with a total concentration of 100 mg/L and iron ions (Fe²⁺) with a content of 800 mg/L is taken, and its pH value is adjusted to 9 with lime powder, and then the eluent is pumped into the primary processing unit 6 to obtain 20.2 kg of precipitate containing rare earth and purified supernatant; the content of rare earth and iron in the purified supernatant is less than 0.5 mg/L, and the sedimentation rate of rare earth is bigger than 99%. Magnesium sulfate and sodium dihydrogen phosphate are added into the purified supernatant, and then the supernatant is stirred and reacted for 15 min, and subsequently pumped into the secondary processing unit 7 to obtain 13 kg of struvite and the purified supernatant after the second purification, wherein the ammonia nitrogen content of the purified supernatant after the second purification is 13 mg/L, and the ammonia nitrogen removal rate is bigger than 87%, which can be reused for preparing the eluent again.

Embodiments 1 and 2 show that the invention can effectively remove low-concentration ammonia nitrogen ion solution and rare earth ion solution which are difficult to treat, and can reuse waste, thus avoiding environmental pollution caused by waste; besides, all products produced in the process do not need to be disposed, and can be recycled, so that the eluent waste liquid can be fully purified.

### Embodiment 3

The first thickener 62 is communicated with the primary spiral dehydrator 63 through a pipeline, and an electromagnetic flowmeter and an electromagnetic valve are connected in series on the pipeline; the electromagnetic flowmeter and the electromagnetic valve are respectively electrically connected with the PLC controller 21, and the PLC controller 21 receives the signal of the electromagnetic flowmeter to control the electromagnetic valve to realize the flow and total amount of water flowing into the primary spiral dehydrator 63; in the same way, the relation among the secondary thickener 72, the secondary spiral dehydrator 73 and the PLC controller 21 is the same, so that the sewage can be transferred between different parts by the gravity flow of the sewage, which further reduces energy consumption.

In the description of the invention, it should be understood that the terms “longitudinal”, “transverse”, “upper”, “lower”, “front”, “rear”, “left”, “right”, “vertical”, “horizontal”, “top”, “bottom”, “inner” and “outer” are based on the directions or positional relationships shown in the drawings, which are only for convenience of describing the invention, but do not indicate or imply that the referred devices or elements must have the specific orientation, be constructed and operated in the specific orientation, so they cannot be understood as limiting the invention.

The above embodiments only describe the preferred mode of the invention, but do not limit the scope of the invention. On the premise of not departing from the design spirit of the invention, various modifications and improvements made by those of ordinary skill in the art to the technical scheme of the invention shall fall within the protection scope determined by the claims of the invention.

What is claimed is:

1. A movable thick and dehydration device for an eluent sediment from medium-and low-concentration ammonia nitrogen, comprising: a container, an eluent preparing mechanism, a transferring mechanism, a plurality of pumping mechanisms (1), a transport vehicle, and a purifying device arranged on the transport vehicle;
wherein the purifying device comprises an automatic controlling system (2), an eluent collecting pool (3), a primary sedimentation pool (4), a secondary sedimentation pool (5), a primary processing unit (6), and a secondary processing unit (7); the primary processing unit (6) and the secondary processing unit (7) are both arranged in the container;
wherein the eluent collecting pool (3) is configured to be communicated with an external mine eluent waste port, and the eluent collecting pool (3) is communicated with the primary sedimentation pool (4) through one of the plurality of pumping mechanism (1); the primary sedimentation pool (4) is fixedly connected to and communicated with the primary processing unit (6) through one of the plurality of pumping mechanisms (1);
the primary processing unit (6) and the secondary processing unit (7) are fixedly connected to and communicated with the secondary sedimentation pool (5) through ones of the plurality of pumping mechanisms (1); the primary processing unit (6) is communicated with the transferring mechanism, and the secondary processing unit (7) is individually communicated with the eluent preparing mechanism and the transferring mechanism; the automatic controlling system (2) is fixedly installed on the primary sedimentation pool (4), the secondary sedimentation pool (5), the primary processing unit (6) and the secondary processing unit (7), and is further electrically connected to the plurality of pumping mechanisms (1).

2. The movable thick and dehydration device according to claim 1, wherein the primary processing unit (6) comprises a primary thickener (62), a primary spiral dehydrator (63) and a primary sand filtering purifier (64) which are individually fixedly arranged on a bottom surface of an inner cavity of the container; the primary sedimentation pool (4) is fixedly connected to and communicated with the primary thickener (62) through the pumping mechanism (1); the primary thickener (62) is fixedly connected to and communicated with the primary sand filtering purifier (64) and the primary spiral dehydrator (63) through two of the plurality of pumping mechanisms (1) respectively; the primary sand filtering purifier (64) is fixedly connected to and communicated with the secondary sedimentation pool (5) through the pumping mechanism (1); the secondary sedimentation pool (5) is fixedly connected to and communicated with the secondary processing unit (7) through the pumping mechanism (1); and the primary spiral dehydrator (63) is communicated with the transferring mechanism.

3. The movable thick dehydration device according to claim 2, wherein the secondary processing unit (7) comprises a secondary thickener (72), a secondary spiral dehydrator (73) and a second sand filter liquid purifier (74) which are individually fixedly arranged on the bottom surface of the inner cavity of the container; the secondary sedimentation pool (5) is fixedly connected to and communicated with the secondary thickener (72) through the pumping mechanism (1); the secondary thickener (72) is fixedly connected to and communicated with the secondary sand filtering purifier (74) and the secondary spiral dehydrator (73) through two of the plurality of pumping mechanisms (1); the secondary sand filtering purifier (74) is fixedly connected to and communicated with the eluent preparing mechanism through the pumping mechanism (1); and the secondary spiral dehydrator (73) is communicated with the transferring mechanism.

4. The movable thick dehydration device according to claim 3, wherein the automatic controlling system (2) comprises a PLC controller (21), a plurality of liquid level meters (22) and a plurality of pH meters (23); the PLC controller (21) is arranged at a side of the primary sedimentation pool (4); the primary sedimentation pool (4) and the secondary sedimentation pool (5) are respectively fixedly provided with ones of the plurality of pH meters (23); the primary sedimentation pool (4) and the secondary sedimentation pool (5) are respectively fixedly provided with ones of the plurality of liquid level meters (22); the plurality of liquid level meters (22), the plurality of pH meters (23) and the plurality of pumping mechanisms (1) are respectively electrically connected to the PLC controller (21).

5. The movable thick dehydration device according to claim 3, wherein the primary sedimentation pool (4), the secondary sedimentation pool (5) and the eluent collecting pool (3) all are quick assembly and disassembly structures.

6. A movable thick dehydration method for eluent sediment from medium- and low-concentration ammonia nitrogen using the movable thick dehydration device according to claim 1, comprising the following steps:
liquid collecting: importing a mine eluent into the eluent collecting pool (3);
primary preparation: importing the eluent into the primary sedimentation pool (4), and adding lime into the eluent to obtain turbid liquid;
primary multiplex treating: importing the turbid liquid from the primary sedimentation pool (4) into the primary processing unit (6), and importing the turbid liquid which is processed by the primary processing unit (6) into the secondary sedimentation pool (5) and the transferring mechanism;
secondary preparing: adding sodium dihydrogen phosphate and magnesium sulfate into the secondary sedimentation pool (5), and stirring and resting the eluent for reaction for a predetermined time to obtain a suspension; and
secondary multiplex treating: importing the suspension from the secondary sedimentation pool (5) into the secondary processing unit (7), and importing the suspension which is processed by the secondary processing unit (7) into the eluent preparing mechanism and the transferring mechanism.

7. The movable thick dehydration method according to claim 6, wherein the primary processing unit (6) comprises a primary thickener (62), a primary spiral dehydrator (63) and a primary sand filtering purifier (64); and in the step of primary multiplex treating, the turbid liquid of the primary sedimentation pool (4) is imported into the primary thickener (62) for clarifying and stratifying, a supernatant is then imported into the primary sand filtering purifier (64) and a purified eluent is imported into the secondary sedimentation pool (5), a lower turbid liquid is imported into the primary spiral dehydrator (63) and an export product of the primary spiral dehydrator (63) is imported into the transferring mechanism.

8. The movable thick dehydration method according to claim 7, wherein in the step of secondary preparing, the time of the stirring and resting is 10 min-30 min.

9. The movable thick dehydration method according to claim 7, wherein the secondary processing unit (7) comprises a secondary thickener (72), a secondary spiral dehydrator (73) and a second sand filtering purifier (74); and in the step of secondary multiplex treating, a turbid liquid generated by the reaction in the secondary sedimentation pool (5) is imported into the secondary thickener (72) for clarifying and stratifying, a supernatant is imported into the secondary sand filtering purifier (74) and a purified solution is imported into the eluent preparing mechanism, a lower turbid liquid is imported into the secondary spiral dehydrator (73) and an export product of the secondary spiral dehydrator (73) is imported into the transferring mechanism.
